(19) United States
(12) Patent Application Publication
(10) Pub. No.: US 2013/0179593 A1
(43) Pub. Date: Jul. 11, 2013

(54) CLOUD COMPUTING CONTROLLED GATEWAY FOR COMMUNICATION NETWORKS

(71) Applicant: QUALCOMM INCORPORATED, San Diego, CA (US)

(72) Inventors: Wayne G. DUNLAP, Austin, TX (US); Michael W. CUBBAGE, Austin, TX (US)

(73) Assignee: QUALCOMM INCORPORATED, San Diego, CA (US)

(21) Appl. No.: 13/737,387

(22) Filed: Jan. 9, 2013

Related U.S. Application Data
(60) Provisional application No. 61/584,628, filed on Jan. 9, 2012.

(51) Int. Cl. H04L 12/56

(52) U.S. Cl. CPC H04L 45/42
USPC 709/244

(57) ABSTRACT

A router or gateway can implement a cloud connected proxy for monitoring and routing network traffic of the local area network (LAN). A secure communication link is established between the router and a web-based application running in a cloud computing network to proxy communications between one or more network devices of the LAN and the web-based application. If inbound network traffic is received at the router via the secure communication link from the web-based application, the inbound network traffic is forwarded from the router directly to the one or more network devices that process the inbound network traffic to implement a web-based service on the LAN. If outbound network traffic is received at the router from the one or more network devices of the LAN, the outbound network traffic is forwarded to the web-based application via the secure communication link.

### RELATED APPLICATIONS

This application claims the priority benefit of U.S. Provisional Application Ser. No. 61/584,628 filed on Jan. 9, 2012.

### BACKGROUND

Embodiments of the inventive subject matter generally relate to the field of communication networks and, more particularly, to a cloud computing controlled gateway for communication networks.

Local area networks (LANs), such as home or office networks, typically include a router (or gateway) that connects the LAN to a wide area network (WAN) and routes packets between the two networks. Various network devices in the LAN can access and download information from the Internet via the router, and the router can manage the various packet streams from the different network devices accessing the Internet (and other outbound network traffic). The router of the LAN can also provide various security features, such as a firewall, to restrict inbound network traffic and prevent unauthorized or malicious attempts to remotely access the LAN.

### SUMMARY

Various embodiments are disclosed for implementing a cloud computing controlled router for a LAN. In one embodiment, a secure communication link is established between a router of a LAN and a remote computer system to proxy communications between one or more network devices of the LAN and the remote computer system. Network traffic associated with the secure communication link between the router and the remote computer system is detected at the router. It is determined whether the network traffic received at the router is inbound network traffic or outbound network traffic. If it is determined that the network traffic is inbound network traffic received via the secure communication link from an application running in the remote computer system and destined for the one or more network devices of the LAN, the inbound network traffic is forwarded from the router directly to the one or more network devices on the LAN. If it is determined that the network traffic is outbound network traffic received from the one or more network devices of the LAN and destined for the application running in the remote computer system, the outbound network traffic is forwarded to the application running in the remote computer system via the secure communication link.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram illustrating a cloud computing controlled router for a communication network, according to some embodiments;

FIG. 2 is another example block diagram illustrating the cloud computing controlled router for a communication network including a cloud connected proxy and a web-based application hosted in a cloud computing network, according to some embodiments;

FIG. 3 is another example block diagram illustrating the cloud computing controlled router for a communication network including a cloud connected proxy and a web-based application hosted in a cloud computing network, according to some embodiments;

FIG. 4 is a flow diagram illustrating example operations for implementing the cloud computing controlled router system shown in FIGS. 1-3, according to some embodiments; and

FIG. 5 is a block diagram of one embodiment of a network device including a cloud connected proxy mechanism for a communication network, according to some embodiments.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to utilizing the cloud computing controlled routers in home local area networks (LANs), in other examples the cloud computing controlled routers can be used in any suitable type of network, such as an office network, a multi-dwelling network, a university network, etc. In other instances, well-known instruction instances, protocols, structures and techniques have not been shown in detail in order not to obfuscate the description.

Currently, various web-based applications and services exist that take advantage of the network connected home. In network connected homes, various devices such as security camera, digital thermostats, digital video recorder (DVR) boxes, refrigerators, home lighting, etc. are connected to the home LAN along with notebook computers, desktop computers, mobile phones, etc. However, for the web-based applications and services to communicate with the LAN devices, a corresponding LAN-based application or dedicated LAN-based hardware device is typically needed on the LAN. For example, a LAN-based software program may need to be running on a machine (e.g., PC) that is always on, or a dedicated hardware device may need to be added to the LAN that is always on and runs the LAN-based software program. Furthermore, each web-based application and service may need its own corresponding LAN-based application. For example, a web-based service for remotely controlling and viewing video from security cameras typically needs its own LAN-based application running on a LAN computer system that is always on, and a web-based service for remotely controlling a digital thermostat typically needs a separate LAN-based application running locally in the LAN. Therefore, the more network connected devices are added to the LAN, the more LAN-based applications are needed in the LAN for communicating with the corresponding web-based services, which can increase the cost of the network connected devices and/or the cost of setting up and maintaining the LAN. Also, each LAN-based application typically queries the associated device(s) on the local LAN and sends the information via a router (or gateway) to the corresponding web-based service. However, the web-based service usually needs to receive a communication from the LAN-based application first (via the router) in order to send information to the associated devices on the LAN. In other words, the router of the LAN typically does not allow inbound communications from the web-based service on a WAN (e.g., for directly querying the local devices on the LAN) without the router first having sent outbound communications from the LAN-based application to the web-based service on the WAN.

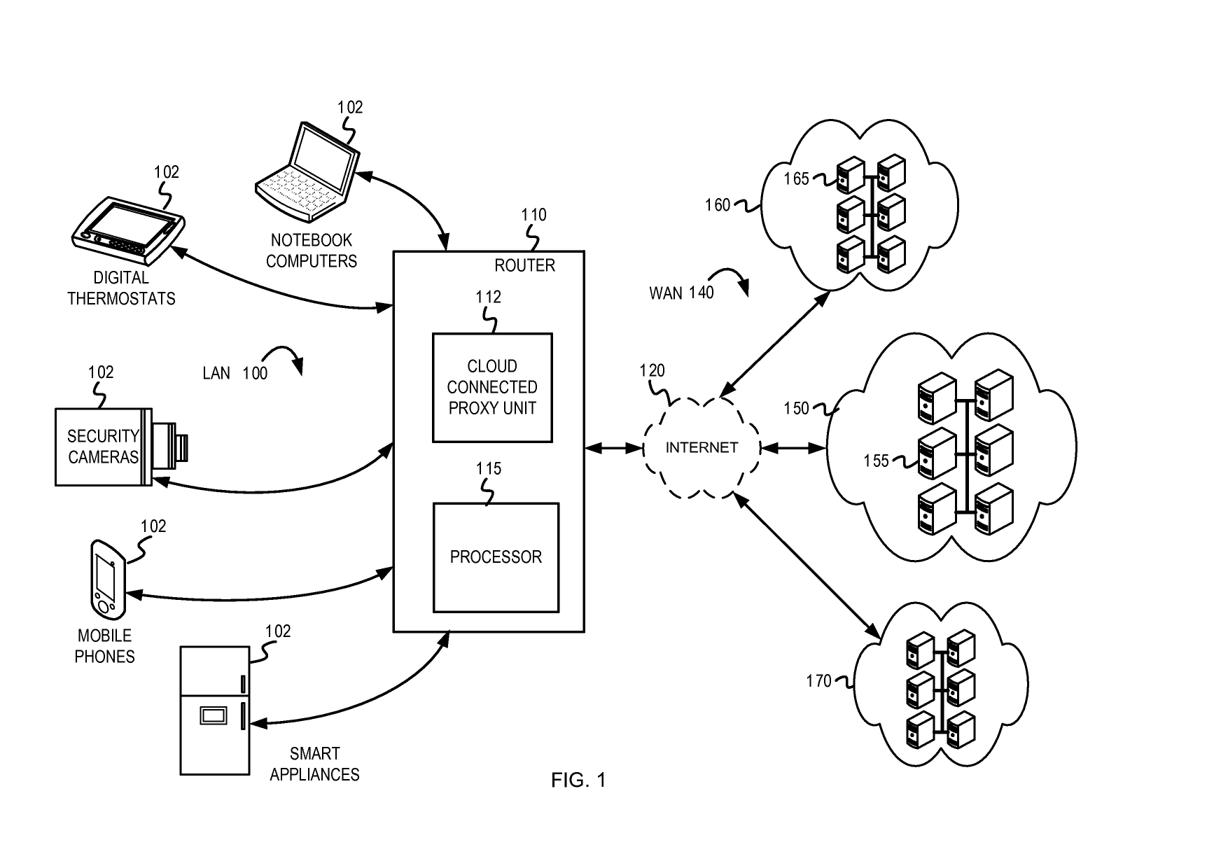

In some implementations, a router (or gateway) in a LAN may implement a cloud computing based proxy that allows web-based applications and services to directly communicate with the local network devices on the LAN via the router without needing LAN-based software programs locally on the LAN that are associated with the web-based applications and services. The cloud computing based proxy on the router can also allow the web-based applications and services to directly communicate with the local network devices on the LAN (i.e., inbound communications) via the router without having to first receive outbound communications from the LAN devices, as will be further described below with reference to FIGS. 1-5.

FIG. 1 is an example block diagram illustrating a cloud computing controlled router for a communication network, according to some embodiments. The LAN 100 comprises a plurality of network devices 102 and a router 110. The plurality of network devices 102 may include various type of wired and wireless networking devices, such as but not limited to notebook computers, tablet computers, mobile phones, desktop computers, security cameras, televisions, DVR boxes, digital thermostats, gaming consoles, smart appliances, and other suitable network connected devices. The router 110 (or gateway) may be a network traffic managing node between two or more networks that receives, processes, and routes packets associated with the networks. It is noted, however, that in other embodiments the LAN 100 may include a network traffic managing node (not shown) that is configured to perform various functions for the network(s), e.g., a server computer system that incorporates one or more of a cable modem, gateway/router, wireless access point, bridge, switch and/or storage, which may also implement the functionality described herein with reference to FIGS. 1-5. For some embodiments of the system illustrated in FIG. 1, the router 110 allows the network devices 102 of the LAN 100 to access the WAN 140 and receive content from the WAN 140. The LAN 100 may be one of many LANs that form the WAN 140, which may be generally referred to as the Internet 120. As illustrated, the WAN 140 may also include various networks of servers (and other network devices and software) 150, 160, and 170. In one example, each network of servers can implement cloud computing on the Internet 120, which will be referenced herein as the cloud computing network 150 (or the cloud 150), the cloud computing network 160 (or the cloud 160), and the cloud computing network 170 (or the cloud 170). The router 110 may allow the LAN 100 to obtain the benefit of various services provided by the cloud 150, 160, and 170 via the Internet 120. Various other routers (not shown) servicing other LANs can also connect to the cloud 150, 160, and 170. It is noted that the Internet 120 is depicted with a dashed line to indicate that the LAN 100, cloud 150, 160, 170 and other members of the WAN 140 may be considered part of the Internet 120 (although shown outside of the cloud in FIG. 1).

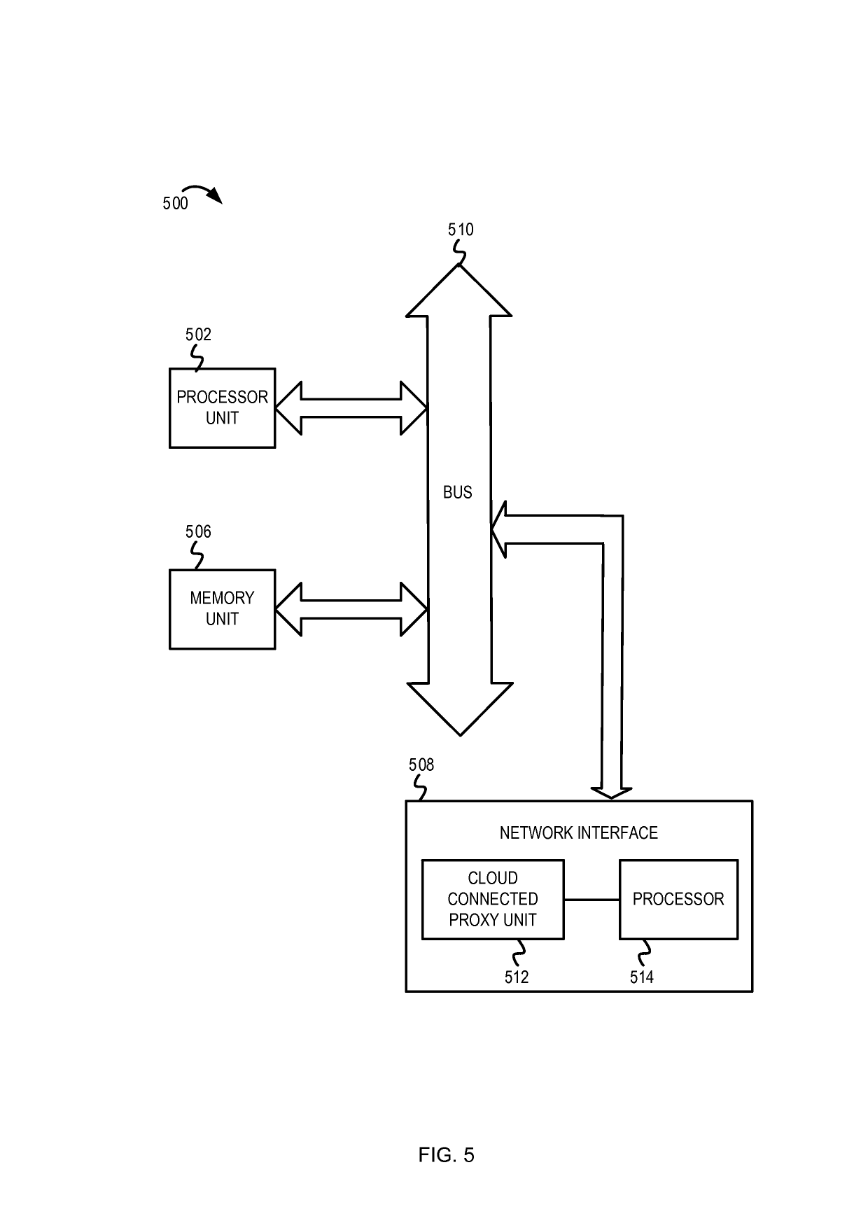

In some embodiments, the router 110 includes a processor 115 and a cloud connected proxy unit 112 configured to establish a secure connection (also referred to as a secure communication link) with web-based applications and services (e.g., implemented in the cloud 150, 160 and/or 170) to allow the web-based services to directly access and communicate with the local network devices 102 in the LAN 100 via the router 110. The cloud connected proxy unit 112 may allow inbound communications via the secure connection without the need to host various corresponding LAN-based applications on the LAN 100 and without having to first send outbound communications to the web-based services, as will be further described below. In some implementations, the processor 115 and the cloud connected proxy unit 112 may be implemented in a network interface card (or module) of the router 110. In one example, the processor 115 and the cloud connected proxy unit 112 may be implemented in one or more integrated circuits (ICs) in the network interface card (e.g., in a system-on-a-chip (SoCs)). In other implementations, the router 110 may include a plurality of network interface cards and circuit boards (e.g., a motherboard), and the plurality of network interface cards and circuit boards may implement the cloud connected proxy unit 112 and the processor 115 in a distributed fashion. Although not shown in FIG. 1, in some implementations, the router 110 may include one or more additional processors (besides processor 115), memory units and other components (e.g., as shown in FIG. 5 below). In some embodiments, the processor 115 of the router 110 can execute program instructions associated with the cloud connected proxy unit 112 to implement, at least in part, the cloud computing based proxy described herein.

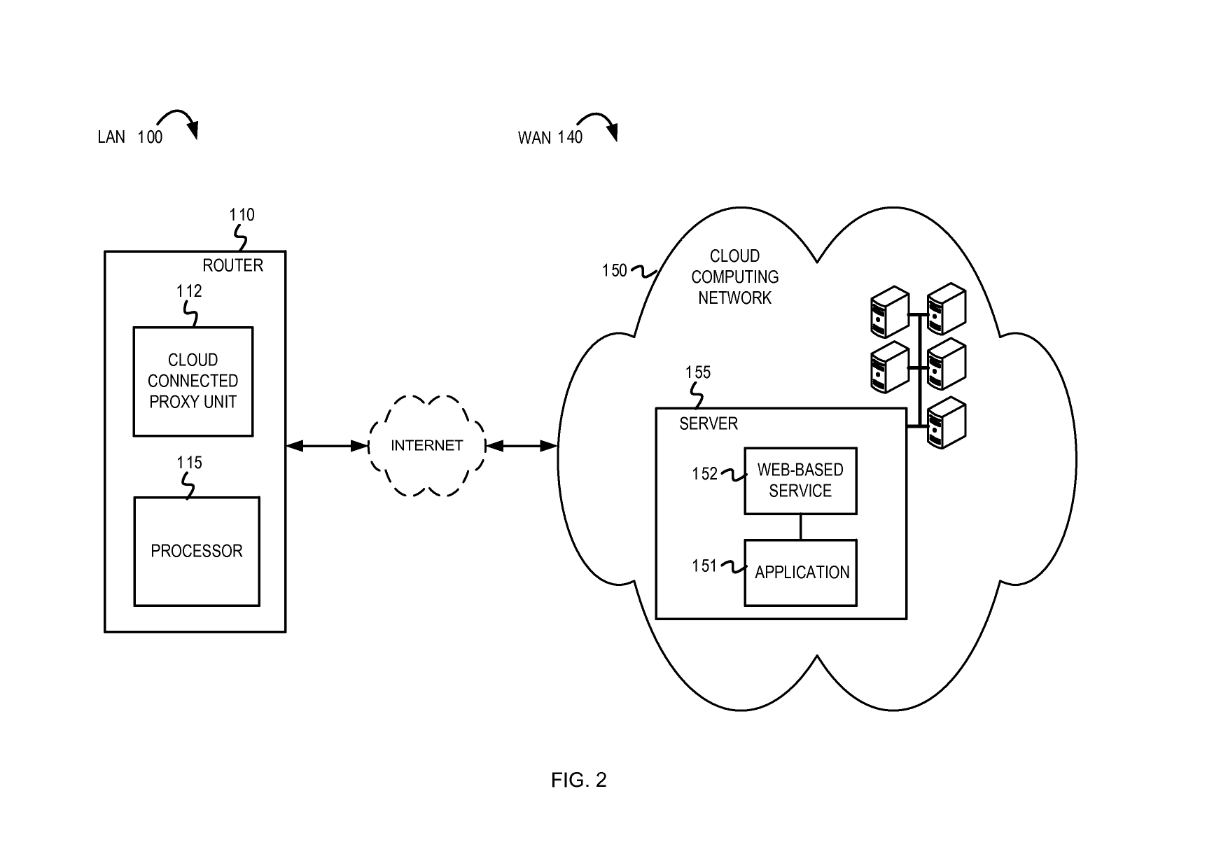

In some implementations, instead of locally hosting and managing applications (and, in some cases, dedicated hardware devices) in the LAN that are associated with the corresponding web-based services (e.g., LAN security cameras and the corresponding web-based monitoring service), the cloud connected proxy unit 112 of the router 110 allows the applications for the web-based services to be remotely hosted on a cloud computing network (e.g., the cloud 150) via the Internet 120. As shown in FIG. 2, in one example, the server 155 of the cloud 150 can remotely run and manage an application 151 (also referred to as a web-based application) associated with a corresponding web-based service 152, and communicate with the cloud connected proxy unit 112 to implement the web-based service in the LAN 100. The cloud 150, 160 and/or 170 can also run applications associated with web-based services for all the associated routers (i.e., routers that implement the cloud computing based proxy) and LANs in the WAN 140. Since the cloud connected proxy unit 112 of the router 110 operates as a proxy for communications between the LAN devices and the application 151 running in the cloud 150, the LAN devices can operate as if the application 151 associated with the web-based service 152 is running in the router 110 (even though the application 151 is running in the cloud 150). In other words, the LAN devices can transmit packets directly to the cloud connected proxy unit 112 of the router 110 as if the application 151 associated with the web-based service 152 is running in the router 110, and the cloud connected proxy unit 112 can proxy communications from the LAN devices to the web-based application 151 (and vice versa) via a secure connection. By running the applications associated with the web-based services in the cloud 150, the complexity and cost of the router 110 is reduced, and the LAN 100 is not subject to the limited amount of available resources (e.g., processing power, memory, flash storage, etc.) inherently associated with routers. Furthermore, by establishing a secure connection between the router 110 and the cloud 150, the cloud connected proxy unit 112 allows the web-based application associated with the web-based service to directly communicate with any of the associated LAN devices (i.e., inbound communications) via the secure connection without the web-based application (or web-based service) needing to first receive communications from the LAN devices (i.e., outbound communications).

Furthermore, by eliminating the need for a LAN-based software program (and, in some cases, a dedicated hardware device) associated with the web-based service, the cost and complexity of the LAN and of the network devices of the LAN can be reduced. For example, instead of developing LAN-based applications that run in the LAN 100 for querying the LAN devices 102 and for communicating with the web-based service via the router 110, device manufacturers and/or service providers can develop web-based applications (e.g., application 151 that runs in the cloud 150) that can communicate directly with the LAN devices 102 via the cloud connected proxy unit 112 of the router 110. For example, a manufacturer of LAN security cameras can develop web-based applications associated with the web-based monitoring service it provides customers, instead of developing LAN-based applications for the LAN security cameras that need to be run locally in a LAN computer system. In addition to reducing the overall cost and complexity of the LAN and LAN devices, utilizing web-based applications improves the ease of use (and further reduces cost) for customers and the service provider (and/or device manufacturer) by reducing or eliminating software updates on the LAN side and performing most or all of the software updates at the cloud side without affecting the LAN devices.

In some implementations, the user of the LAN devices can provide credentials (e.g., username and password) to the cloud connected proxy unit 112 of the router 110, and the proxy unit 112 can then establish the secure connection with the cloud 150. The cloud connected proxy unit 112 can create the secure connection to solve any firewall and NAT issues associated with inbound communications at the router 110. This allows the web-based application to send inbound communications (e.g., commands, content, etc.) directly to any of the associated LAN devices via the router 110 at any time using the secure connection, and without first needing to receive outbound communications from the LAN devices. As described above, the cloud connected proxy unit 112 also operates as a proxy for communications sent via the secure connection, so that applications running in the cloud 150 appear to be running on the router 110 to the LAN devices. For example, all inbound packets (e.g., IP packets) received from the web-based application via the cloud-based secure connection would be proxied directly to the associated LAN devices 102 on the LAN 100 through this connection. Also, the outbound packets received from LAN devices 102 destined for the web-based application would also be proxied via the router 110 to the web-based application running on one or more servers of the cloud 150.

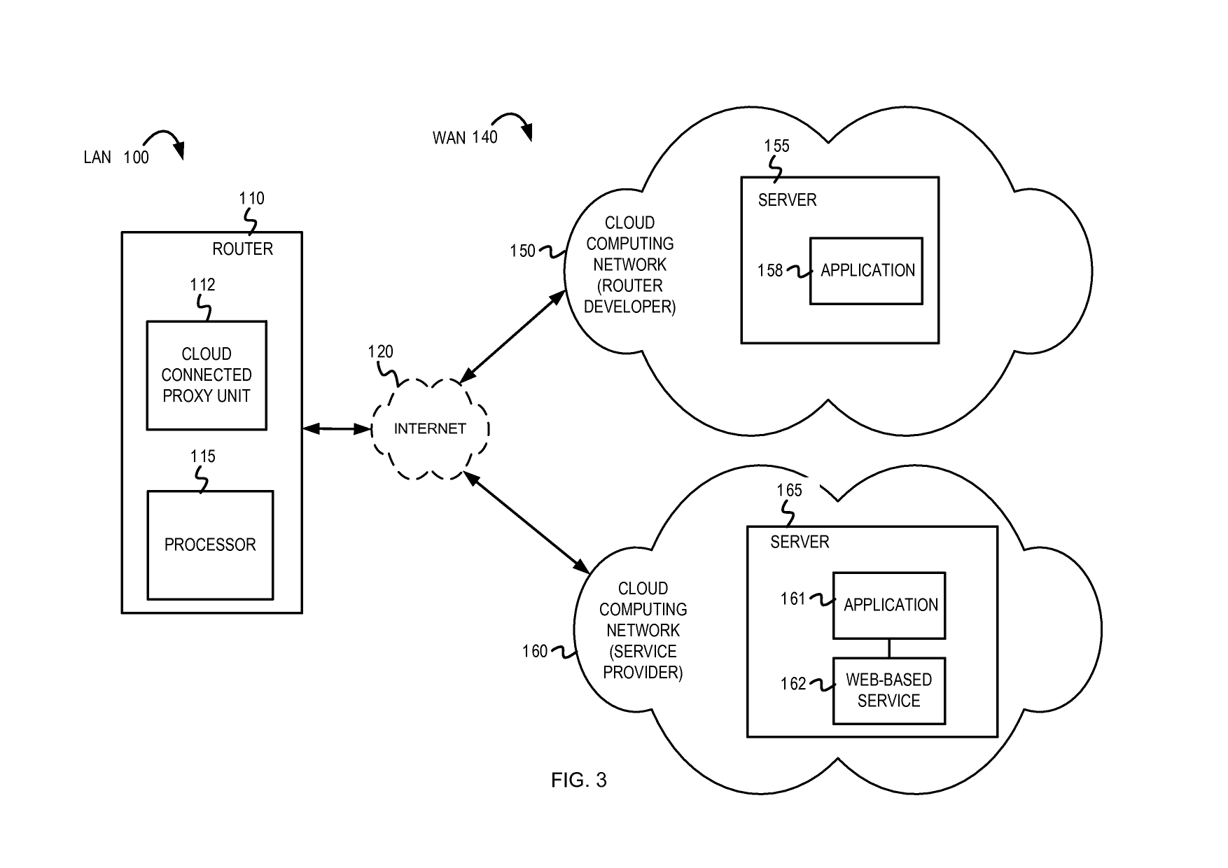

In some implementations, the web-based application associated with the web-based service can be stored and executed in a cloud computing network managed by the designer and/or developer of the routers with the cloud connected proxy (and/or their business partners). For examine, the server 155 of the cloud 150 shown in FIG. 2 may be one of a network of servers managed (in a single location or in a distributed fashion) by the designer and/or developer of the router 110 (and/or their business partners). In other implementations, the service providers and/or LAN device manufacturers may host the web-based applications in their own cloud computing networks (e.g., the same network of servers that provide the web-based service). For example, as shown in FIG. 3, a service provider and/or LAN device developer/manufacturer can host the web-based application 161 associated with the web-based service 162 in one of the servers (e.g., server 165) of their cloud computing network 160. In this example, the application 161 running in one of the servers of the cloud 160 can communicate (e.g., via the Internet 120) with an application in the cloud 150 (e.g., application 158 in the server 155), which establishes the secure connection with the router 110. In other words, in this example, the application 158 establishes the secure connection with the router 110 similarly as was described above, but the web-based application 161 associated with the web-based service 162 is hosted in a different network (e.g., cloud 160). It is noted, however, that in other embodiments additional security mechanisms and other arrangements may be implemented by the service providers (and/or LAN device manufacturers) and the router designer/developer such that the web-based application 161 associated with the web-based service 162 (which is hosted in the cloud 160) can directly access the router 110 by establishing the secure connection directly with the cloud connected proxy unit 112.

In one example, a security camera manufacturer and service provider can develop web-based applications associated with the web-based monitoring services it provides customers. The web-based monitoring applications and services can allow customers to communicate directly with the LAN security cameras via the cloud connected proxy unit of each of the corresponding routers in the different LANs of the WAN 140 (e.g., proxy unit 112 of router 110). When a user logs in to a website or otherwise accesses the web-based monitoring service, the web-based application associated with the web-based service can send commands and other communications directly to the LAN security cameras via the router 110 using a secure connection that is established between the cloud connected proxy unit 112 of the router 110 and the cloud computing network that hosts the web-based application. In one example, the user can log in to a website hosted in the server network managed by the designer and/or developer of the router 110 (e.g., the cloud computing network 150). In another example, the user can log in to a website hosted by a different server network (e.g., the cloud computing network 160) that is managed by the service provider (and/or LAN device developer), and the cloud 160 can communicate with the cloud 150 that has established the secure connection with the router 110, as was described above. The user can view video from the security cameras and control the security cameras remotely (e.g., turn on or off the cameras, receive security alerts, move the cameras, switch between video from different cameras, etc.). Furthermore, as described above, the web-based application can send the inbound communications to the router 110 of the LAN 100 any time without having to first receive an outbound communication (or without continuously receiving multiple outbound communications) from the LAN devices via the router 110.

In some implementations, the cloud computing network that hosts the web-based application that interfaces with the router 100 (e.g., the cloud 150 managed by the router designer/developer) may implement an Application Programming Interface (API) to allow third party application developers to write applications to talk to the cloud 150. As long as the owner of the router 110 provides these third applications with the credentials to establish the secure connection at the cloud 150 with the router 110, the third party applications can directly access the LAN devices via secure connection between the cloud 150 and the cloud connected proxy unit 112 of router 110. This way, third party developers can write applications that appear to be running on the router 110 of the user's LAN 100, even though the applications are running in the cloud 150 or at the third party cloud 160. In some implementations, the cloud 150 may also implement a Java® Virtual Machine (JVM) and the Android™ environment to allow third party developers to write Android applications. Users can then “download” the third party applications from the LANs and run them on their cloud connected gateway accounts associated with the cloud 150. In other words, instead of downloading the applications to a LAN device or to the router, the user can gain access or subscribe to use the application via their cloud connected gateway account. Similarly as was described above, the cloud 150 can proxy all IP traffic through the routers (e.g., router 110 of LAN 100), so it appears that the applications are running on the router 110, even though the applications are running on the cloud 150 without CPU or memory limitations. It may also appear to the users of the LAN that the third party applications are running on their routers/LAN. It is noted that in other implementations the cloud 150 may also implement other types of operating system environments to allow third party developers to write applications for other mobile operating systems in addition to Android.

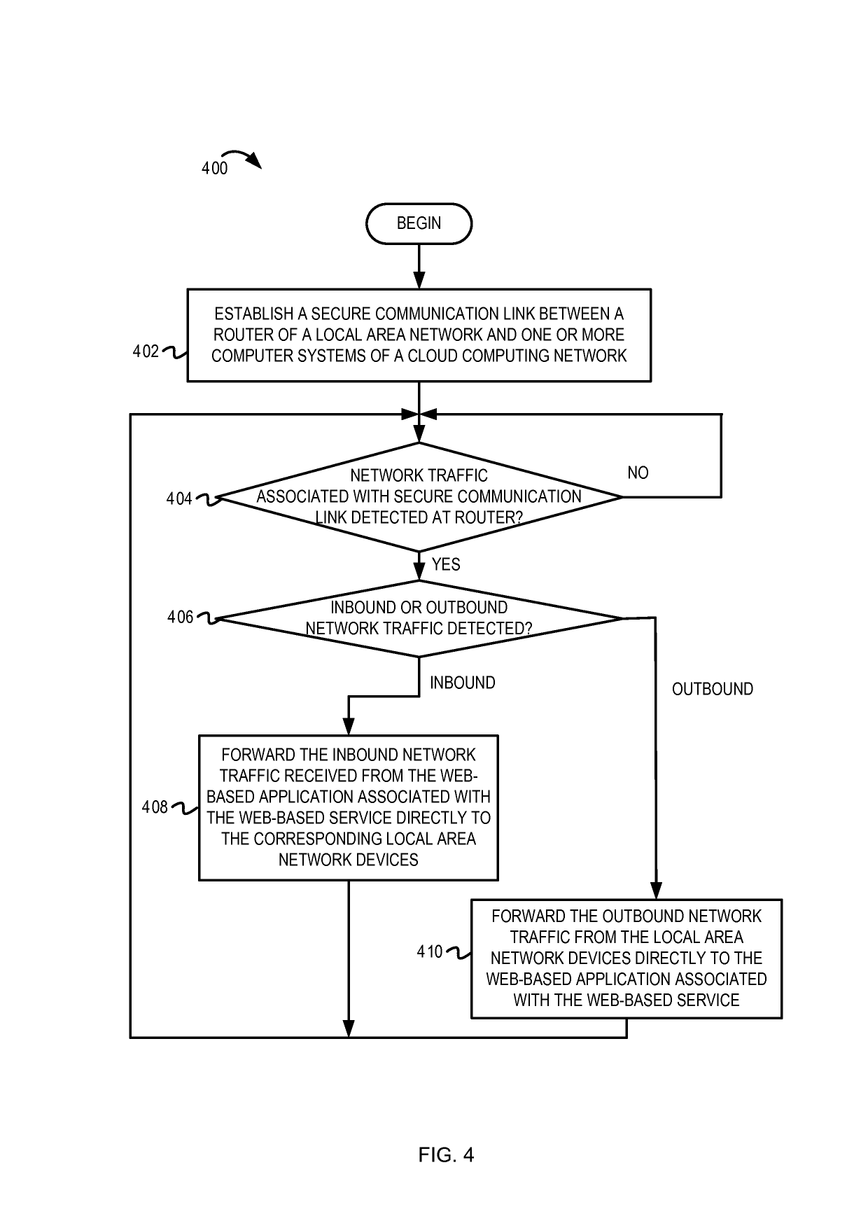

FIG. 4 is a flow diagram (“flow”) 400 illustrating example operations for the cloud computing controlled router system shown in FIGS. 1-3, according to some embodiments. Beginning at block 402, a secure communication link is established between the router 110 of the LAN 100 and one or more computer systems (e.g., servers) of the cloud computing network 150. In one implementation, the cloud connected proxy unit 112 of the router 110 is configured to establish a secure communication link between the router 110 and a web-based application running in one or more of the servers of the cloud 150 that is associated with a web-based service. The cloud connected proxy unit 112 can utilize the secure communication link to proxy communications between the LAN devices and the web-based application. In one example, to establish the secure communication link, the cloud connected proxy unit 112 can request the user to enter credentials (e.g., username and password), and the router 110 provides the credentials to the web-based application running in the cloud 150 that is associated with the web-based service. Also, the cloud connected proxy unit 112 can associate the secure communication link with the network addresses and port numbers of the LAN devices and of the corresponding remote servers that host web-based applications associated with the web-based service. For example, the cloud connected proxy unit 112 can associate the secure communication link with an Internet socket address comprising an IP address and port number. By associating the network addresses and port numbers of the LAN devices and remote servers with the secure communication link, the router 110 can determine which inbound and outbound network traffic should be routed via the secure communication link (and for inbound communications, which network traffic is unauthorized and should be blocked). It is noted that in other implementations, in addition to the network address and port number, the router 110 can also detect and process other indicators that may be included within the network traffic, e.g., device identifiers such as device serial numbers or MAC identifiers. It is also noted that the router 110 and the cloud 150 can implement one or more of various types of encryption and authentication techniques for the secure communication link. After block 402, the flow continues at block 404.

At block 404, it is determined whether network traffic associated with the secure communication link is detected at the router 110. In one implementation, the cloud connected proxy unit 112 detects network traffic received at the router 110 that is associated with the secure communication link between the router 110 and the cloud 150. For example, in order to detect network traffic associated with the secure communication link, the cloud connected proxy unit 112 detects packets associated with the network addresses (source and/or destination network addresses) and port numbers of the LAN devices and of the corresponding web-based application associated with the web-based service (and/or other packet header information). If the cloud connected proxy unit 112 does not detect network traffic associated with the secure communication link, the flow loops back to block 404 to continue monitoring the network traffic received at the router. If the cloud connected proxy unit 112 detects network traffic associated with the secure communication link (e.g., based on the network addresses, port numbers, etc.), the flow continues to block 406.

At block 406, it is determined whether the network traffic associated with the secure communication link that is detected at the router is inbound network traffic or outbound network traffic with respect to the LAN 100. In one implementation, the cloud connected proxy unit 112 determines whether the detected network traffic is inbound or outbound network traffic based, at least in part, on the source and destination network addresses and port numbers associated with the received packets. For example, if the cloud connected proxy unit 112 detects packets with the IP address of one or more of the servers of the cloud 150 that run the web-based application (or an Internet socket address comprising the IP address and a port number associated with communications between the web-based application running in the cloud 150 and the router 110 (and/or the corresponding LAN devices)), the cloud connected proxy unit 112 determines the network traffic is inbound network traffic with respect to the LAN 100. As described above, the router 110 can also detect other packet header information in the network packets to detect inbound communications, e.g., the network address of the LAN devices as the destination address and/or device identifiers associated with the LAN devices. If the router 110 determines the network traffic is inbound network traffic, the flow continues at block 408. In one embodiment, if the cloud connected proxy unit 112 detects (1) packets with the source network address of the LAN devices, (2) the destination address as the IP address of one or more of the servers of the cloud 150 that run the web-based application, and/or (3) other relevant information in the packets (e.g., port number), the cloud connected proxy unit 112 determines the network traffic is outbound network traffic with respect to the LAN 100. If the router 110 determines the network traffic is outbound network traffic, the flow continues at block 410.

At block 408, if inbound network traffic associated with the secure communication link is detected at the router 110, the inbound network traffic received from the web-based application associated with the web-based service is forwarded directly to the corresponding LAN devices. In one implementation, the cloud connected proxy unit 112 can operate as a proxy to forward the inbound network traffic (e.g., commands, content, etc.) directly to the corresponding LAN devices (e.g., the LAN devices that implement the web-based service). For example, if the inbound network traffic includes commands from a web-based service for remotely monitoring security cameras, the cloud connected proxy unit 112 can forward the commands directly to the security cameras in the LAN, instead of first sending the commands to a local monitoring application being executed in a computer or a dedicated hardware device in the LAN, which then sends the commands to the security cameras. Furthermore, as described above, by serving as a proxy to the inbound network traffic associated with secure communication link, the cloud connected proxy unit 112 can allow the web-based application to directly communicate with any of the LAN devices at any time via the router 110 without the web-based application on the WAN side having to first receive outgoing communications from the LAN devices (via the router 110). While operating as a proxy for the inbound communications, the cloud connected proxy unit 112 can establish the secure communication link to solve any firewall and network address translation (NAT) issues (and/or other security issues) associated with inbound communications at the router 110. The web-based application can send any types of inbound packets to the LAN 100 via the secure communication link (e.g., IP packets, non-IP packets, broadcast packets, multicast, etc.). After the inbound traffic is forwarded to the corresponding LAN device(s), the flow loops back to block 404 to continue monitoring the network traffic received at the router 110.

At block 410, if outbound network traffic associated with the secure communication link is detected at the router 110, the outbound network traffic received from the LAN devices is forwarded directly to the web-based application associated with the web-based service. In one implementation, the cloud connected proxy unit 112 can operate as a proxy to forward the outbound network traffic directly to the web-based application running in the corresponding remote network (e.g., the cloud 150). In one implementation, the cloud connected proxy unit 112 can also keep track of the listeners on the WAN side, such as the different web-based applications running on the cloud 150 that are associated with various web-based services (e.g., security camera monitoring, temperature control, DVR control, etc.). When the cloud connected proxy unit 112 receives outbound communications from one or more of the LAN devices, the cloud connected proxy unit 112 can determine if there is a listener associated with the outbound communications. In other words, the cloud connected proxy unit 112 can determine if one of the available web-based applications on the WAN side are associated with the outbound network traffic. For example, if the outbound network traffic is associated with the LAN security cameras and the web-based service for remote monitoring of the security cameras, the cloud connected proxy unit 112 can detect the outbound network traffic is from the LAN security cameras and determine if there is an associated web-based application on the WAN side with an established secure communication link to the router 110. If the cloud connected proxy unit 112 identifies a web-based application associated with the outbound communications, the cloud connected proxy unit 112 proxies the communications to the WAN side (e.g., to the corresponding application on the cloud 150). The cloud connected proxy unit 112 may drop the outbound packets if it does not identify a listener in the WAN side (i.e., it does not detect a secure communication link with a corresponding web-based application, detects the web-based application is down, etc.). The network devices can send any types of outbound packets to the cloud 150 via the secure communication link, for example, IP packets, non-IP packets, broadcast packets, etc. After the outbound traffic is forwarded to the corresponding web-based application associated with the web-based service, the flow loops back to block 404 to continue monitoring the network traffic received at the router 110.

It should be understood that FIGS. 1-4 are examples meant to aid in understanding embodiments and should not be used to limit embodiments or limit scope of the claims. Embodiments may perform additional operations, fewer operations, operations in a different order, operations in parallel, and some operations differently. For example, although the operations of blocks 404 and 406 are shown as being performed sequentially, it is noted that the operations of blocks 404 and 406 can be performed concurrently.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a nontransitory computer readable signal medium or computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 5 is a block diagram of one embodiment of a network device 500 (which may be router 110 of FIGS. 1-3 or router 110 plus other components associated with router 110) including a cloud connected proxy mechanism for a communication network, according to some embodiments. In some implementations, the network device 500 is a network traffic managing node between two or more networks (e.g., a LAN and a WAN) that receives, processes, and routes packets associated with the networks; for example, the network traffic managing node may be a router/gateway of a LAN (e.g., LAN 100 shown in FIG. 1). It is noted, however, that in other implementations the network device 500 may be other suitable types of network devices that can be configured to implement the functionality described above with reference to FIGS. 1-4, such as a cable modem, a wireless access point, a network bridge, a network switch, a desktop computer, a gaming console, a mobile computing device, etc. The network device 500 includes a processor unit 502 (possibly including multiple processors, multiple cores, multiple nodes, and/or implementing multi-threading, etc.). The network device 500 also includes a memory unit 506. The memory unit 506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable storage media. The network device 500 also includes a bus 510 (e.g., PCI, ISA, PCI-Express, HyperTransport®, InfiniBand®, NuBus, AHB, AXI, etc.), and network interface(s) 508 that include at least one of a wireless network interface (e.g., a Bluetooth interface, a WLAN 802.11 interface, a WiMAX interface, a ZigBee® interface, a Wireless USB interface, etc.) and a wired network interface (e.g., an Ethernet interface, a powerline communication interface, etc.). As illustrated, the network interface(s) 508 also includes a cloud connected proxy unit 512 and a processor 514. For example, the cloud connected proxy unit 512 and the processor 514 may be implemented within a network interface card or network interface module of the network interface(s) 508. The cloud connected proxy unit 512 and the processor 514 may be operable to implement the cloud connected proxy mechanism for the network device 500, as describe above with reference to FIGS. 1-4.

Any one of these functionalities may be partially (or entirely) implemented in hardware and/or on the processor unit 502. For example, the functionality may be implemented with one or more application specific integrated circuits, one or more system-on-a-chip (SoC), or other type of integrated circuit(s), in logic implemented in the processor unit 502, in a co-processor on a peripheral device or card, in a distributed fashion between the processor 514 (and memory) implemented within the network interface 508 and the processor unit 502 (and memory unit 506), etc. Further, realizations may include fewer or additional components not illustrated in FIG. 5 (e.g., video cards, audio cards, additional network interfaces, peripheral devices, etc.). The processor unit 502, the memory unit 506, and the network interfaces 508 are coupled to the bus 510. Although illustrated as being coupled to the bus 510, the memory unit 506 may be coupled to the processor unit 502.

While the embodiments are described with reference to various implementations and exploitations, it will be understood that these embodiments are illustrative and that the scope of the inventive subject matter is not limited to them. In general, techniques for implementing a cloud computing controlled router with a cloud connected proxy for a communication network as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
establishing a communication link between a router of a local area network and a remote computer system to proxy communications between one or more network devices of the local area network and the remote computer system;
detecting, at the router, network traffic associated with the communication link between the router and the remote computer system;
determining whether the network traffic received at the router is inbound network traffic or outbound network traffic;
if determined that the network traffic is inbound network traffic received via the communication link from an application running in the remote computer system and destined for the one or more network devices of the local area network, forwarding the inbound network traffic from the router directly to the one or more network devices on the local area network; and
if determined that the network traffic is outbound network traffic received from the one or more network devices of the local area network and destined for the application running in the remote computer system, forwarding the outbound network traffic from the router to the application running in the remote computer system via the communication link.

2. The method of claim 1, wherein said detecting, at the router, network traffic associated with the communication link between the router and remote computer system comprises detecting, at the router, one or more packets associated with the communication link based, at least in part, on header information associated with the one or more packets.

3. The method of claim 2, wherein the header information include one or more of a source network address, a destination network address, a port number, and a device identifier.

4. The method of claim 1, further comprising, if determined that the network traffic is inbound network traffic received via the communication link from the application associated with a web-based service of the cloud computing network and destined for the one or more network devices of the local area network, forwarding the inbound network traffic from the router directly to the one or more network devices that process the inbound network traffic to implement the web-based service on the local area network.

5. The method of claim 4, further comprising bypassing any intermediate device communicatively coupled between the router and the one or more network devices in forwarding the inbound network traffic from the router to the one or more network devices, wherein the one or more network devices process the inbound network traffic to implement the web-based service on the local area network.

6. The method of claim 1, further comprising, if determined that the network traffic is inbound network traffic received via the communication link from the application running in the remote computer system and destined for the one or more network devices of the local area network, automatically forwarding the inbound network traffic from the router directly to the one or more network devices on the local area network to allow the application running in the remote computer system to communicate with the one or more network devices via the communication link.

7. The method of claim 1, further comprising, if determined that the network traffic is outbound network traffic from the one or more network devices of the local area network and destined for the application associated with a web-based service of the cloud computing network, forwarding the outbound network traffic to the application running in the remote computer system of the cloud computing network via the communication link.

8. The method of claim 7, wherein said forwarding the outbound network traffic to the application running in the remote computer system of the cloud computing network via the communication link comprises determining whether at least one application running in the cloud computing network is associated with the outbound network traffic received at the router from the one or more network devices of the local area network and forwarding the outbound network traffic to the application running in the cloud computing network via the communication link.

9. The method of claim 1, wherein said establishing the communication link between the router of the local area network and the remote computer system comprises establishing a secure communication link, comprising obtaining, at the router, credentials from a user of the local area network and providing the credentials from the router to the application running in the remote network computer.

10. A method comprising:
establishing a communication link between a router of a local area network and a web-based application running in a remote computer system of a cloud computing network to proxy communications between one or more network devices of the local area network and the web-based application associated with a web-based service of the cloud computing network;
detecting, at the router, network traffic associated with the communication link between the router and the web-based application associated with the cloud computing network;
determining whether the network traffic received at the router is inbound network traffic or outbound network traffic;
if determined that the network traffic is inbound network traffic received via the communication link from the web-based application and destined for the one or more network devices of the local area network, forwarding the inbound network traffic from the router to the one or more network devices that process the inbound network traffic to implement the web-based service on the local area network; and
if determined that the network traffic is outbound network traffic received from the one or more network devices of the local area network and destined for the web-based application, forwarding the outbound network traffic from the router to the web-based application running in the remote computer system of the cloud computing network via the communication link.

11. The method of claim 10, further comprising bypassing any intermediate device communicatively coupled between the router and the one or more network devices when forwarding the inbound network traffic from the router to the one or more network devices, wherein the one or more network devices process the inbound network traffic to implement the web-based service on the local area network.

12. The method of claim 10, further comprising, if determined that the network traffic is inbound network traffic received via the communication link from the web-based application running associated with the cloud computing network and destined for the one or more network devices of the local area network, automatically forwarding the inbound network traffic from the router directly to the one or more network devices on the local area network to allow the web-based application to communicate with the one or more network devices via the communication link.

13. A network router comprising:
one or more processors; and
one or more memory units configured to store one or more instructions which, when executed by the one or more processors, causes the network router to perform operations that comprise:
establishing a communication link between the network router of a local area network and a web-based application running in a remote computer system of a cloud computing network to proxy communications between one or more network devices of the local area network and the web-based application associated with the cloud computing network, wherein the web-based application is associated with a web-based service of the cloud computing network;
detecting network traffic associated with the communication link between the network router and the web-based application associated with the cloud computing network;
determining whether the network traffic received at the network router is inbound network traffic or outbound network traffic;
if determined that the network traffic is inbound network traffic received via the communication link from the web-based application and destined for the one or more network devices of the local area network, forwarding the inbound network traffic from the network router directly to the one or more network devices that process the inbound network traffic to implement the web-based service on the local area network; and
if determined that the network traffic is outbound network traffic received from the one or more network devices of the local area network and destined for the web-based application, forwarding the outbound network traffic from the network router to the web-based application running in the remote computer system of the cloud computing network via the communication link.

14. A network router comprising:
a processor; and
a cloud connected proxy unit communicatively coupled with the processor, the cloud connected proxy unit configured to:
establish a communication link between the network router of a local area network and a remote computer system to proxy communications between one or more network devices of the local area network and the remote computer system;
detect network traffic associated with the communication link between the network router and the remote computer system;
determine whether the network traffic received at the network router is inbound network traffic or outbound network traffic;
if determined that the network traffic is inbound network traffic received via the communication link from an application running in the remote computer system and destined for the one or more network devices of the local area network, forward the inbound network traffic from the network router directly to the one or more network devices on the local area network; and
if determined that the network traffic is outbound network traffic received from the one or more network devices of the local area network and destined for the application running in the remote computer system, forward the outbound network traffic from the network router to the application running in the remote computer system via the communication link.

15. The network router of claim 14, wherein the cloud connected proxy unit configured to detect network traffic associated with the communication link between the network router and remote computer system comprises the cloud connected proxy unit configured to detect one or more packets associated with the communication link based, at least in part, on header information associated with the one or more packets.

16. The network router of claim 14, wherein the application running in the remote computer system of a cloud computing network is associated with a web-based service of the cloud computing network, and wherein, if determined that the network traffic is inbound network traffic received via the communication link from the application associated with the cloud computing network and destined for the one or more network devices of the local area network, the cloud connected proxy unit is configured to forward the inbound network traffic from the network router directly to the one or more network devices that process the inbound network traffic to implement the web-based service on the local area network.

17. The network router of claim 16, wherein the cloud connected proxy unit is further configured to bypass any intermediate device communicatively coupled between the network router and the one or more network devices when forwarding the inbound network traffic from the network router directly to the one or more network devices, wherein the one or more network devices process the inbound network traffic to implement the web-based service on the local area network.

18. The network router of claim 14, wherein, if determined that the network traffic is inbound network traffic received via the communication link from the application running in the remote computer system and destined for the one or more network devices of the local area network, the cloud connected proxy unit is further configured to automatically forward the inbound network traffic from the network router directly to the one or more network devices on the local area network to allow the application running in the remote computer system to communicate with the one or more network devices via the communication link.

19. The network router of claim 14, wherein the application running in the remote computer system of a cloud computing network is associated with a web-based service of the cloud computing network, and wherein, if determined that the network traffic is outbound network traffic from the one or more network devices of the local area network and destined for the application associated with the cloud computing network, the cloud connected proxy unit is configured to forward the outbound network traffic to the application running in the remote computer system of the cloud computing network via the communication link.

20. The network router of claim 19, wherein the cloud connected proxy unit configured to forward the outbound network traffic to the application running in the remote computer system of the cloud computing network via the communication link comprises the cloud connected proxy unit configured to determine whether at least one application running in the cloud computing network is associated with the outbound network traffic received at the network router from the one or more network devices of the local area network and forward the outbound network traffic to the application running in the cloud computing network via the communication link.

21. A machine-readable storage medium having stored therein instructions, which when executed by one or more processors causes the one or more processors to perform operations that comprise:
establishing a communication link between a network router of a local area network and a remote computer system to proxy communications between one or more network devices of the local area network and the remote computer system;
detecting, at the network router, network traffic associated with the communication link between the network router and the remote computer system;
determining whether the network traffic received at the network router is inbound network traffic or outbound network traffic;
if determined that the network traffic is inbound network traffic received via the communication link from an application running in the remote computer system and destined for the one or more network devices of the local area network, forwarding the inbound network traffic from the network router directly to the one or more network devices on the local area network; and
if determined that the network traffic is outbound network traffic received from the one or more network devices of the local area network and destined for the application running in the remote computer system, forwarding the outbound network traffic from the network router to the application running in the remote computer system via the communication link.

22. The machine-readable storage medium of claim 21, wherein said operation of detecting network traffic associated with the communication link between the network router and remote computer system comprises detecting one or more packets associated with the communication link based, at least in part, on header information associated with the one or more packets.

23. The machine-readable storage medium of claim 21, wherein said operations further comprise, if determined that the network traffic is inbound network traffic received via the communication link from the application associated with a web-based service of the cloud computing network and destined for the one or more network devices of the local area network, forwarding the inbound network traffic from the router directly to the one or more network devices that process the inbound network traffic to implement the web-based service on the local area network.

24. The machine-readable storage medium of claim 23, wherein said operations further comprise bypassing any intermediate device communicatively coupled between the network router and the one or more network devices when forwarding the inbound network traffic from the router to the one or more network devices, wherein the one or more network devices process the inbound network traffic to implement the web-based service on the local area network.

25. The machine-readable storage medium of claim 21, wherein said operations further comprise, if determined that the network traffic is inbound network traffic received via the communication link from the application running in the remote computer system and destined for the one or more network devices of the local area network, automatically forwarding the inbound network traffic from the router directly to the one or more network devices on the local area network to allow the application running in the remote computer system to communicate with the one or more network devices via the communication link.

26. The machine-readable storage medium of claim 21, wherein said operations further comprise, if determined that the network traffic is outbound network traffic from the one or more network devices of the local area network and destined for the application associated with a web-based service of the cloud computing network, forwarding the outbound network traffic to the application running in the remote computer system of the cloud computing network via the communication link.

27. The machine-readable storage medium of claim 26, wherein said operation of forwarding the outbound network traffic to the application running in the remote computer system of the cloud computing network via the communication link comprises determining whether at least one application running in the cloud computing network is associated with the outbound network traffic received at the router from the one or more network devices of the local area network and forwarding the outbound network traffic to the application running in the cloud computing network via the communication link.

28. The machine-readable storage medium of claim 21, wherein said operation of establishing the communication link between the router of the local area network and the remote computer system comprises establishing a secure communication link, comprising obtaining, at the network router, credentials from a user of the local area network and providing the credentials from the router to the application running in the remote network computer.

29. An apparatus comprising:
means for establishing a communication link between a network router of a local area network and a remote computer system to proxy communications between one or more network devices of the local area network and the remote computer system;
means for detecting, at the network router, network traffic associated with the communication link between the network router and the remote computer system;
means for determining whether the network traffic received at the network router is inbound network traffic or outbound network traffic;
means for forwarding the inbound network traffic from the network router directly to the one or more network devices on the local area network, if determined that the network traffic is inbound network traffic received via the communication link from an application running in the remote computer system and destined for the one or more network devices of the local area network; and
means for forwarding the outbound network traffic from the network router to the application running in the remote computer system via the communication link, if determined that the network traffic is outbound network traffic received from the one or more network devices of the local area network and destined for the application running in the remote computer system.

30. The apparatus of claim 29, wherein said means for detecting network traffic associated with the communication link between the network router and remote computer system comprises means for detecting one or more packets associated with the communication link based, at least in part, on header information associated with the one or more packets.

31. The apparatus of claim 29, further comprising means for forwarding the inbound network traffic from the router directly to the one or more network devices that process the inbound network traffic to implement the web-based service on the local area network, if determined that the network traffic is inbound network traffic received via the communication link from the application associated with a web-based service of the cloud computing network and destined for the one or more network devices of the local area network.

32. The apparatus of claim 31, further comprising means for bypassing any intermediate device communicatively coupled between the network router and the one or more network devices when forwarding the inbound network traffic from the router to the one or more network devices, wherein the one or more network devices process the inbound network traffic to implement the web-based service on the local area network.

33. The apparatus of claim 29, further comprising means for automatically forwarding the inbound network traffic from the router directly to the one or more network devices on the local area network to allow the application running in the remote computer system to communicate with the one or more network devices via the communication link, if determined that the network traffic is inbound network traffic received via the communication link from the application running in the remote computer system and destined for the one or more network devices of the local area network.

34. The apparatus of claim 29, further comprising means for forwarding the outbound network traffic to the application running in the remote computer system of the cloud computing network via the communication link, if determined that the network traffic is outbound network traffic from the one or more network devices of the local area network and destined for the application associated with a web-based service of the cloud computing network.

35. The apparatus of claim 34, wherein said means for forwarding the outbound network traffic to the application running in the remote computer system of the cloud computing network via the communication link comprises:
means for determining whether at least one application running in the cloud computing network is associated with the outbound network traffic received at the router from the one or more network devices of the local area network; and
means for forwarding the outbound network traffic to the application running in the cloud computing network via the communication link.

36. The apparatus of claim 29, wherein said means for establishing the communication link between the router of the local area network and the remote computer system comprises means for establishing a secure communication link, comprising obtaining, at the network router, credentials from a user of the local area network and providing the credentials from the router to the application running in the remote network computer.
